(19) United States
(12) Patent Application Publication
(10) Pub. No.: US 2006/0220909 A1
(43) Pub. Date: Oct. 5, 2006

(54) Traffic light

(75) Inventor: Chi-Fan Lin, Shinjuang City (TW)

Correspondence Address: TROXELL LAW OFFICE PLLC, SUITE 1404, 5205 LEESBURG PIKE, FALLS CHURCH, VA, 22041, US

(73) Assignee: Cochief Industrial Co., Ltd.

(21) Appl. No.: 11/097,297

(22) Filed: Apr. 4, 2005

(51) Int. Cl. G08G 1/095

(52) U.S. Cl. 340/907

(57) ABSTRACT

A traffic light forms a yellow light by blending a red light and a green light according to the color blending principle. Red and green light emitting diodes are provided for showing the red, green, or yellow light. The traffic light comprises red-green light emitting diodes mounted on a substrate, wherein each one of the red-green light emitting diodes comprises a red and a green light emitting chip packaged in a plastic casing. A power source transforming circuit is mounted on the substrate for electrically conducting the red and the green light emitting chips respectively when it is desired to show a red light and a green light respectively, and for electrically conducting the red and green light emitting chips simultaneously when it is desired to show a yellow light. Accordingly, a single set of light source can show red, green, or yellow light so its production cost is reduced.

### FIELD OF THE INVENTION

The present invention relates to an improved structure of a traffic light, and more particularly to the traffic light that utilizes the principle of color blending to form a yellow light, thereby reducing the number of the light source and the production cost.

### BACKGROUND OF THE INVENTION

The conventional light emitting diode traffic light comprises three independently shown colors, i.e. a red light, a green light, and a yellow light, wherein the lighting and the transformation time of these three lights are controlled by a control program so as to achieve the purpose of showing color. Accordingly, three sets of light sources must be provided simultaneously. As shown in FIG. 1, a time controller A controls these three sets of light sources, i.e. a set of red light emitting diode B1, a set of yellow light emitting diode B2, and a set of green light emitting diode B3. Each set of light emitting diode is composed of a plurality of light emitting diodes having the same color. For example, the set of red light source is composed of a plurality of red light emitting diodes and so on. When it is desired to show the red light, the red light emitting diodes are lighted up. When it is desired to show the yellow light, the yellow light emitting diodes are lighted up. When it is desired to show the green light, the green light emitting diodes are lighted up. Accordingly, the conventional traffic light must equip with three independent light sources so it has large dimension and high production cost.

### SUMMARY OF THE INVENTION

The main object of the present invention is to provide an improved structure of a traffic light that forms a yellow light by lighting up regularly staggered red light emitting diodes and green light emitting diodes simultaneously in accordance with the color blending principle. Accordingly, a single set of light source can show the red light, the green light, or the yellow light. For this reason, both the production cost and the dimension of the light source are reduced.

In order to achieve the aforementioned object, the present invention discloses a traffic light comprising a plurality of red light emitting diodes and a plurality of green light emitting diode on a substrate. Besides, a power source transforming circuit is mounted on the substrate for transforming alternating current into direct current, and a control circuit for controlling the lighting and the transformation time of the light emitting diodes is mounted on the substrate.

The above-mentioned red light emitting diodes and green light emitting diodes are staggered and spread regularly on the substrate. By use of the control circuit to perform control process, the green light emitting diodes are electrically conducted and lighted up when it is desired to show the green light. The red light emitting diodes are electrically conducted and lighted up when it is desired to show the red light. According to the color blending principle, the red light emitting diodes and the green light emitting diodes are electrically conducted and lighted up simultaneously when it is desired to show the yellow light. Alternatively, a plurality of red-green light emitting diodes are spread regularly on the substrate, wherein each red-green light emitting diode comprises a red light emitting chip and a green light emitting chip packaged in a plastic casing to respectively control the lighting color of the light. When it is desired to show the red light, the red light emitting chips are electrically conducted and lighted up. When it is desired to show the green light, the green light emitting chips are electrically conducted and lighted up. When it is desired to show the yellow light, the red light emitting chips and the green light emitting chips are electrically conducted and lighted up at the same time.

Accordingly, a single set of light source can show the red light, the green light, or the yellow light of the traffic light so there is no need to provide three sets of light sources as the conventional traffic light does. For this reason, the budgets for the remaining two sets of light sources can be saved. Since the traffic light only requires one set of light source, the whole dimension and the production cost of the traffic light are both reduced.

The other features and preferred embodiments of the present invention will now be described with reference to the accompanying drawings.

### BRIEF DESCRIPTION OF THE DRAWINGS

FIG. 1 is a schematic diagram illustrating a conventional traffic light.

FIG. 2-1 is a schematic lateral view illustrating a first preferred embodiment of the present invention.

FIG. 2-2 is a schematic front view respectively illustrating the first preferred embodiment of the present invention.

FIG. 3 is a schematic view illustrating the lighting of the red-green light emitting diodes of the present invention.

FIG. 4 is a block diagram illustrating the first preferred embodiment of the present invention.

FIG. 5-1 is a schematic lateral view illustrating a second preferred embodiment of the present invention.

FIG. 5-2 is a schematic front view illustrating the second preferred embodiment of the present invention.

FIG. 6 is a schematic view illustrating the lighting of the traffic light of the present invention.

FIG. 7 is a block diagram illustrating the second preferred embodiment of the present invention.

### DETAILED DESCRIPTION OF THE PREFERRED EMBODIMENT

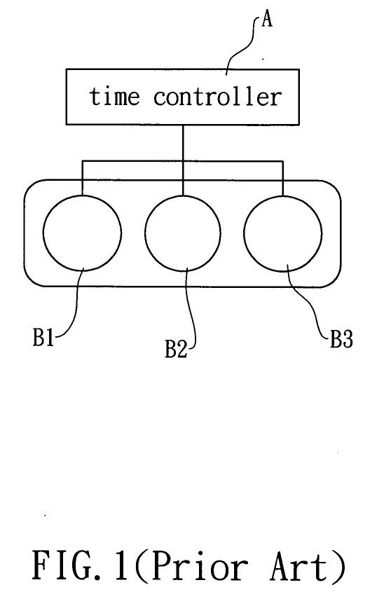

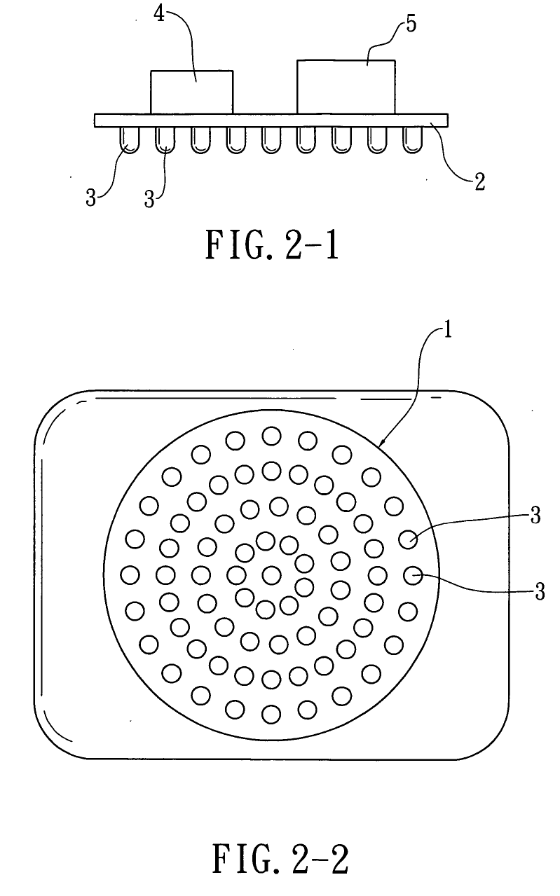

Referring to FIG. 2-1 and FIG. 2-2, a schematic lateral view and a schematic front view respectively illustrating a first preferred embodiment of the present invention are shown. In the traffic light 1 of the present invention, a plurality of red-green light emitting diodes 3, a power source transforming circuit 4 for transforming alternating current into direct current, and a control circuit 5 for controlling the lighting and the transformation time of the light emitting diodes are mounted on a substrate 2.

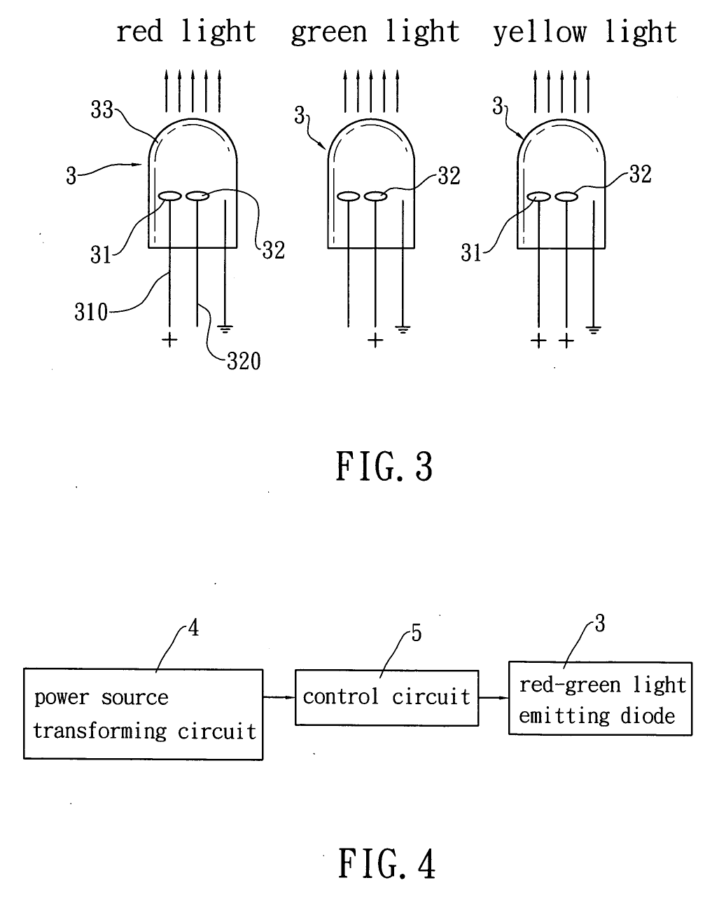

Referring to FIG. 3 and FIG. 4, a schematic view and a block diagram respectively illustrating the red-green light emitting diodes and the first preferred embodiment of the present invention are shown. Each red-green light emitting diode 3 comprises a red light emitting chip 31 and a green light emitting chip 32 packaged in the same plastic casing 33. An electro-conductive pin 310 of the red light emitting chip 31 and an electro-conductive pin 320 of the green light emitting chip 32 are extended out of the plastic casing 33 and respectively connected with the substrate 2, wherein the control circuit 5 controls whether the red light emitting chip 31 and the green light emitting chip 32 is lighted or not.

When the traffic light is in use, the existing alternating current is transformed into the direct current by the power source transforming circuit 4 to provide the control circuit 5 with the electric power, thereby controlling the color showing of the red-green light emitting diodes 3 by means of the control circuit 5. When it is desired to show the green light, the green light emitting chips 32 are electrically conducted and lighted up. When it is desired to show the red light, the red light emitting chips 31 are electrically conducted and lighted up. When it is desired to show the yellow light, the red light emitting chips 31 and the green light emitting chips 32 are electrically conducted and lighted up at the same time in accordance with the principle of color blending. In that case, a single light emitting diode 3 can show the red light, the green light, or the yellow light. In other words, a single set of light source can show the red light, the green light, or the yellow light of the traffic light so there is no need to provide three sets of light sources as the conventional traffic light does. For this reason, the budgets for the remaining two sets of light sources can be saved. Since the traffic light only requires one set of light source, the whole dimension and the production cost of the traffic light are both reduced.

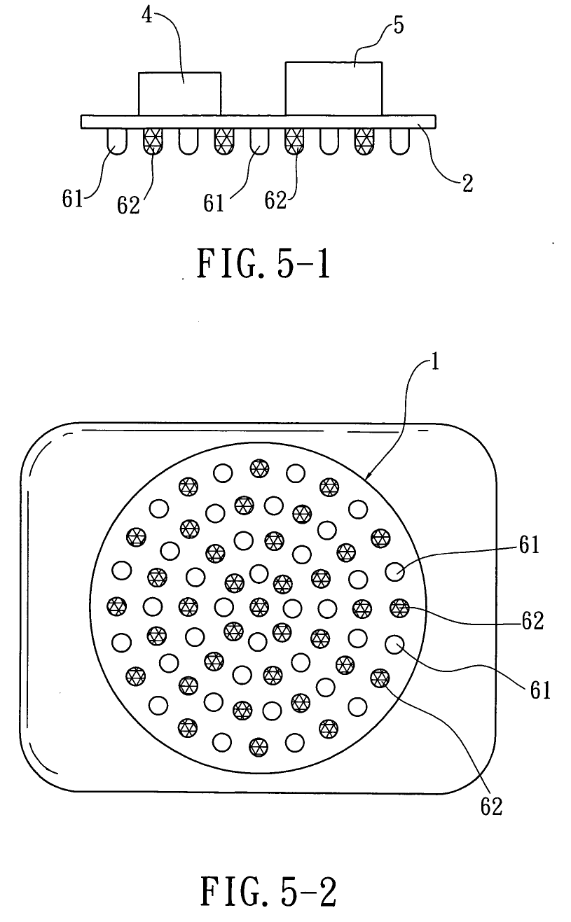

Referring further to FIG. 5-1 and FIG. 5-2, a schematic lateral view and a schematic front view illustrating a second preferred embodiment of the present invention are shown. Several red light emitting diodes 61 and several green light emitting diodes 62 are mounted on the substrate 2 of the traffic light 1 of the present invention, wherein these two kinds of light emitting diodes are staggered and spread regularly.

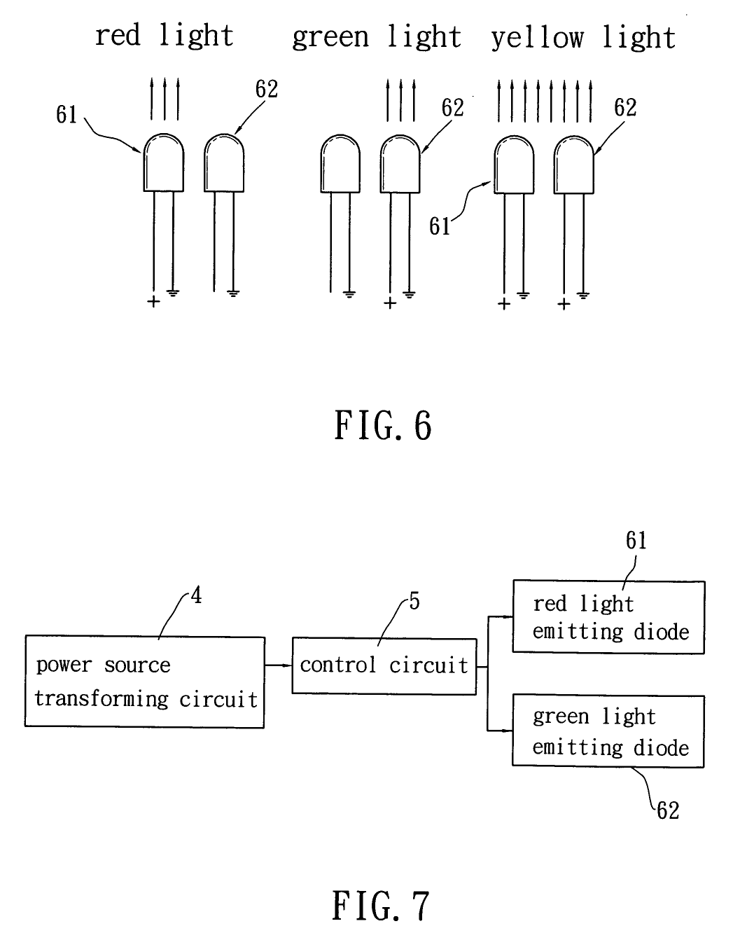

Referring further to FIG. 6 and FIG. 7, these red light emitting diodes 61 and green light emitting diodes 62 are staggered and spread regularly on the substrate. When the traffic light is in use, the existing alternating current is transformed into the direct current by the power source transforming circuit 4 to provide the control circuit 5 with the electric power, thereby controlling the color showing of the red light emitting diodes 61 and the green light emitting diodes 62 by means of the control circuit 5. When it is desired to show the red light, the red light emitting diodes 61 are electrically conducted and lighted up. When it is desired to show the green light, the green light emitting diodes 62 are electrically conducted and lighted up. When it is desired to show the yellow light, the red light emitting diodes 61 and the green light emitting diodes 62 are electrically conducted and lighted up at the same time in accordance with the color blending principle. In that case, a single set of regularly staggered red light emitting diodes and green light emitting diodes can show the red light, the green light, or the yellow light. For this reason, the budgets for the remaining two sets of light sources can be saved. The whole dimension and the production cost of the traffic light are both reduced since the traffic light only requires one set of light source.

For persons skilled in the art, it is apparent that the present invention can achieve the expected purpose according to the aforementioned description. The present invention complies with all requirements of patent rules and is submitted for a patent.

While the preferred embodiment of the invention has been set forth for the purpose of disclosure, modifications of the disclosed embodiment of the invention as well as other embodiments thereof may occur to those skilled in the art. Accordingly, the appended claims are intended to cover all embodiments, which do not depart from the spirit and scope of the invention.

What the invention claimed is:

1. A traffic light comprising:
a substrate;
a plurality of red-green light emitting diodes mounted on said substrate, each of said red-green light emitting diodes comprising: a plastic casing; and a red light emitting chip and a green light emitting chip packaged in said plastic casing; and
a control circuit mounted on said substrate for respectively electrically conducting and lighting up said red light emitting chip and said light emitting chip when it is desired to show a red light and a green light respectively, and for electrically conducting and lighting up said red light emitting chip and said light emitting chip simultaneously when it is desired to show a yellow light.

2. The traffic light of claim 1, further comprising a power source transforming circuit mounted on said substrate.

3. A traffic light comprising:
a substrate;
a plurality of red light emitting diodes and a plurality of green light emitting diodes staggered and spread regularly on said substrate; and
a control circuit mounted on said substrate for respectively electrically conducting and lighting up said red light emitting diodes and said light emitting diodes when it is desired to show a red light and a green light respectively, and for electrically conducting and lighting up said red light emitting diodes and said light emitting diodes simultaneously when it is desired to show a yellow light.

4. The traffic light of claim 3, further comprising a power source transforming circuit mounted on said substrate.
